(19) United States
(12) Patent Application Publication
(10) Pub. No.: US 2025/0293449 A1
(43) Pub. Date: Sep. 18, 2025

(54) Conductive Terminal

(71) Applicants: Dongguan Tarng Yu Electronics Co., Ltd., Dongguan City (CN); Tarng Yu Enterprise co., ltd., New Taipei City (TW)

(72) Inventors: TSUNG-CHI CHEN, New Taipei City (TW); MU-JUNG HUANG, New Taipei City (TW)

(21) Appl. No.: 19/079,461

(22) Filed: Mar. 14, 2025

(30) Foreign Application Priority Data
Mar. 15, 2024 (TW) 113202655

(51) Int. Cl. H01R 13/11; H01R 13/631; H01T 19/00

(52) U.S. Cl. CPC H01R 13/113; H01R 13/631; H01T 19/00

(57) ABSTRACT

A conductive terminal of transmitting signals in an electronic product. The conductive terminal provides a conductive component for joining and comprises a terminal body and a guiding frame body. The guiding frame body is able to guide the joining of the conductive component. When the conductive component joins, the guiding frame body undergoes deformation to accommodate the shape of the conductive component. This reduces the resistance generated by the joining of the conductive terminal and the conductive component, thereby preventing the localized compression of the conductive terminal by the conductive component, which may otherwise cause improper deformation of a part of the conductive terminal. Consequently, the reliability of the electrical connector in which the conductive terminal is installed is enhanced.

### CROSS-REFERENCE TO RELATED APPLICATIONS

This application claims the priority of Republic of China Patent Application No. 113202655 filed on Mar. 15, 2024, in the State Intellectual Property Office of the R.O.C., the disclosure of which is incorporated herein by reference.

### BACKGROUND OF THE INVENTION

### Field of the Invention

The present application relates to a conductive terminal and, more specifically, to a conductive terminal capable of avoiding localized improper deformation caused by localized compression.

### Descriptions of the Related Art

In general, electrical connectors and conductive components are indispensable parts of electronic products. Typically, a conductive component can join a conductive terminal of an electrical connector to transmit electrical signals. However, due to the trend of miniaturization in electrical connectors and their conductive terminals, the conductive terminal is prone to interfering with the joining of the conductive component, causing localized compression of the conductive terminal, which results in localized improper deformation. This, in turn, affects the reliability of signal transmission by the conductive terminal, leading to malfunction or even damage to the electronic product. Therefore, how to prevent the conductive terminal from interfering with the joining of the conductive component is an important criterion for evaluating the reliability of an electrical connector.

It should be noted that, for safety reasons, only electrical connectors with high reliability can be used in electronic products for aviation, maritime, railway, and road transportation applications.

In view of the above, how to provide a conductive terminal that solves the issue of existing miniaturized conductive terminals easily interfering with the joining of conductive components, thereby improving the reliability of electrical connectors, comprise become a technical challenge that the industry is eager to overcome.

### SUMMARY OF THE INVENTION

In view of the drawbacks of the prior art mentioned above, the present application provides a conductive terminal, comprising: a terminal body, the terminal body comprising a terminal internal space and a terminal joining structure; and a guiding frame body, the guiding frame body comprising a first frame wall, a third frame wall, and a fourth frame wall, the first frame wall being respectively connected to the third frame wall and the fourth frame wall to form a part of a frame-shaped guiding structure; wherein the frame-shaped guiding structure is able to guide the conductive component into the terminal internal space and join the terminal joining structure; the first frame wall comprises a first frame wall body and a first frame wall notch, the first frame wall notch extending inward from an edge of the first frame wall body, wherein the inward extension length of the first frame wall notch is a first frame wall notch extension length, the connection length between the third frame wall and the first frame wall is a third frame wall connection length, and the connection length between the fourth frame wall and the first frame wall is a fourth frame wall connection length; and the first frame wall notch extension length is smaller than the third frame wall connection length and the fourth frame wall connection length, so that the structural strength of the first frame wall is weaker than that of the third frame wall and the fourth frame wall, allowing the deformation degree of the first frame wall to be greater than that of the third frame wall and the fourth frame wall when the frame-shaped guiding structure guides the conductive component.

Preferably, the conductive terminal said above, further comprising: a third abutting arm and a fourth abutting arm, the third abutting arm being positioned on the same side as the third frame wall, and the fourth abutting arm being positioned on the same side as the fourth frame wall, and the third abutting arm and the fourth abutting arm respectively extending from the terminal body to abut against the conductive component entering the terminal internal space; and the terminal joining structure comprising a third terminal joining substructure and a fourth terminal joining substructure, the third terminal joining substructure being disposed on the third abutting arm, and the fourth terminal joining substructure being disposed on the fourth abutting arm to join the conductive component.

Preferably, the conductive terminal said above, wherein the third abutting arm and the fourth abutting arm are elastic cantilever arms.

Preferably, the conductive terminal said above, wherein the guiding frame body further comprises a second frame wall, the second frame wall being respectively connected to the third frame wall and the fourth frame wall to form another part of the frame-shaped guiding structure; wherein the second frame wall comprise a second frame wall body and a second frame wall gap, the second frame wall gap extending inward from an edge of the second frame wall body, the width of the second frame wall gap being a second frame wall gap width, and the width of the first frame wall notch being a first frame wall notch width; and the first frame wall notch width is greater than the second frame wall gap width, so that the structural strength of the first frame wall is weaker than that of the second frame wall, allowing the deformation degree of the first frame wall to be greater than that of the second frame wall when the frame-shaped guiding structure guides the conductive component.

Preferably, the conductive terminal said above, further comprising: a first connecting arm and a second connecting arm, the first connecting arm being positioned on the same side as the first frame wall, and the second connecting arm being positioned on the same side as the second frame wall, wherein the first connecting arm connects the first frame wall and the terminal body to form a part of a joining passage, and the second connecting arm connects the second frame wall and the terminal body to form another part of the joining passage; wherein the frame-shaped guiding structure is able to guide the conductive component into the terminal internal space via the joining passage.

Preferably, the conductive terminal said above, wherein the second frame wall gap extends to the second connecting arm, making the structural strength of the second connecting arm weaker than that of the first connecting arm, so that when the frame-shaped guiding structure guides the conductive component, the deformation degree of the second connecting arm is greater than that of the first connecting arm.

Preferably, the conductive terminal said above, wherein the terminal joining structure comprise a first terminal joining substructure and a second terminal joining substructure, the first terminal joining substructure and the second terminal joining substructure being respectively disposed on the first connecting arm and the second connecting arm to join the conductive component.

Preferably, the conductive terminal said above, further comprising: a discharge contact structure, the discharge contact structure being disposed on the third frame wall or the fourth frame wall, wherein during the process in which the frame-shaped guiding structure guides the conductive component, the discharge contact structure contacts the conductive component to provide discharge to the conductive component, and the time at which the discharge contact structure contacts the conductive component is earlier than the time at which the terminal joining structure joins the conductive component.

Preferably, the conductive terminal said above, wherein the discharge contact structure is a protruding structure.

Compared to prior art, the present application provides a conductive terminal of transmitting signals in an electronic product. The conductive terminal provides a conductive component for joining and comprises a terminal body and a guiding frame body. The guiding frame body is able to guide the joining of the conductive component. When the conductive component joins, the guiding frame body undergoes deformation to accommodate the shape of the conductive component. This reduces the resistance generated by the joining of the conductive terminal and the conductive component, thereby preventing the localized compression of the conductive terminal by the conductive component, which may otherwise cause improper deformation of a part of the conductive terminal. Consequently, the reliability of the electrical connector in which the conductive terminal is installed is enhanced.

### BRIEF DESCRIPTION OF THE DRAWINGS

The above and other aspects, features and other advantages of the present invention will be more clearly understood from the following detailed description taken in conjunction with the accompanying drawings, in which:

FIG. 1 is a three-dimensional schematic view of a conductive terminal of the present application from a first viewing angle in an embodiment.

FIG. 2 is a three-dimensional schematic view of a conductive terminal of the present application from a second viewing angle in an embodiment.

FIG. 3 is a top schematic view of a conductive terminal of the present application in an embodiment.

FIG. 4 is a front schematic view of a conductive terminal of the present application in an embodiment.

FIG. 5 is a left-side schematic view of a conductive terminal of the present application in an embodiment.

FIG. 6 is a right-side schematic view of a conductive terminal of the present application in an embodiment.

FIG. 7 is a sectional schematic view of a portion of the conductive terminal shown in FIG. 4, taken along line A-A.

FIG. 8 is a three-dimensional schematic view of a conductive terminal of the present application from a first viewing angle in an embodiment.

FIG. 9 is a three-dimensional schematic view of a conductive terminal of the present application from a second viewing angle in an embodiment.

### DETAILED DESCRIPTION OF THE PREFERRED EMBODIMENT

Embodiments of the present invention will now be described in detail with reference to the accompanying drawings. The invention may, however, be embodied in many different forms and should not be construed as being limited to the embodiments set forth herein. Rather, these embodiments are provided so that this disclosure will be thorough and complete, and will fully convey the scope of the invention to those skilled in the art.

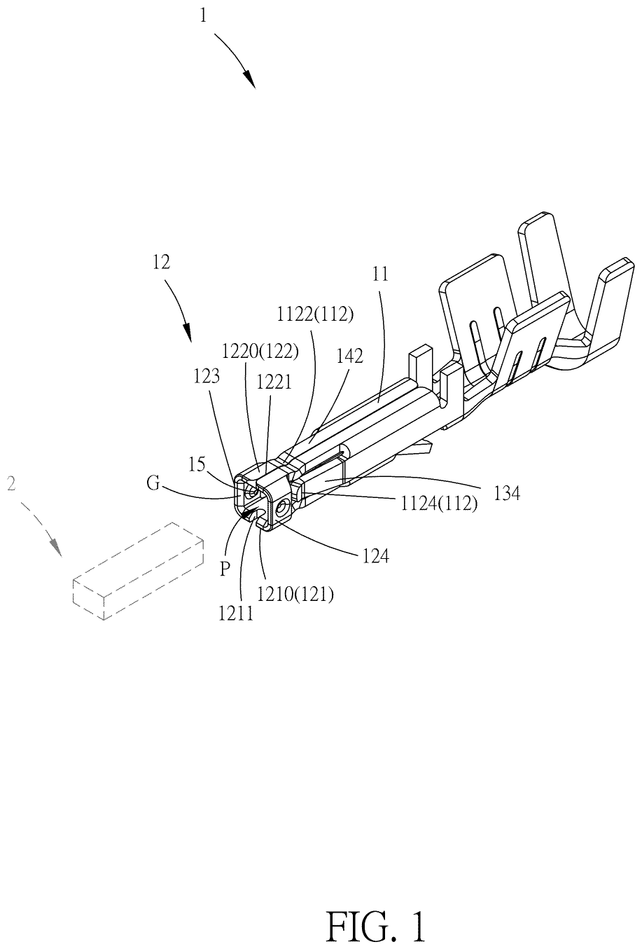

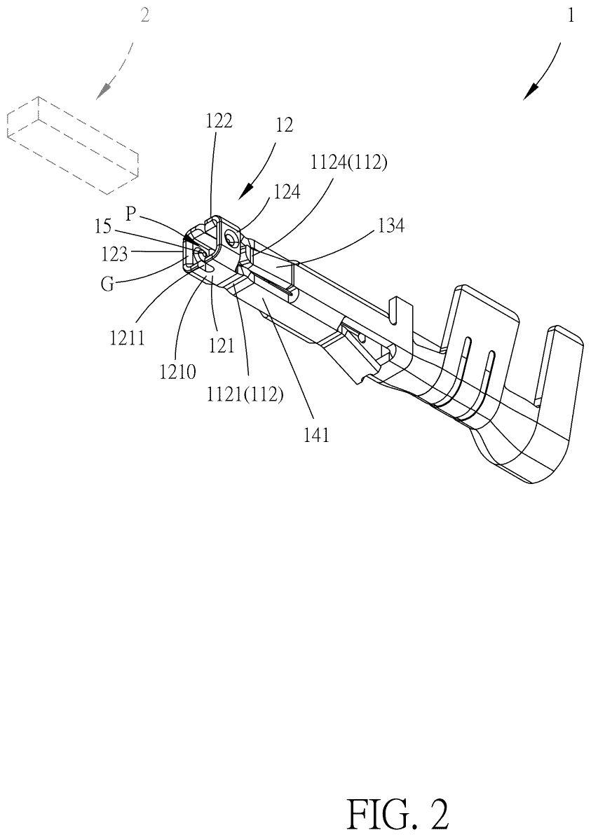

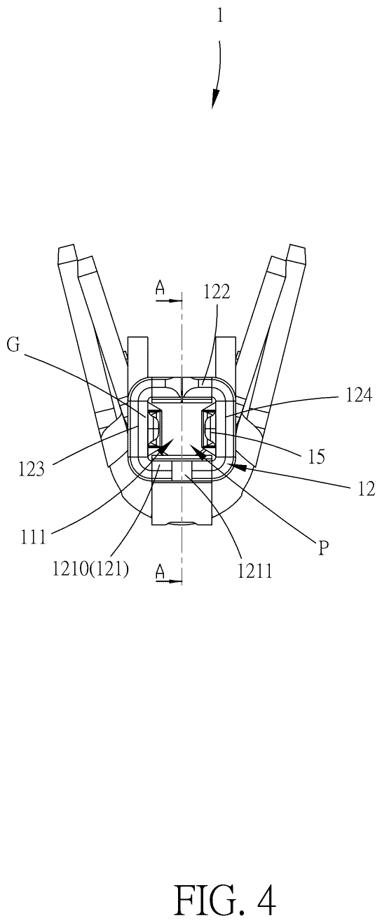

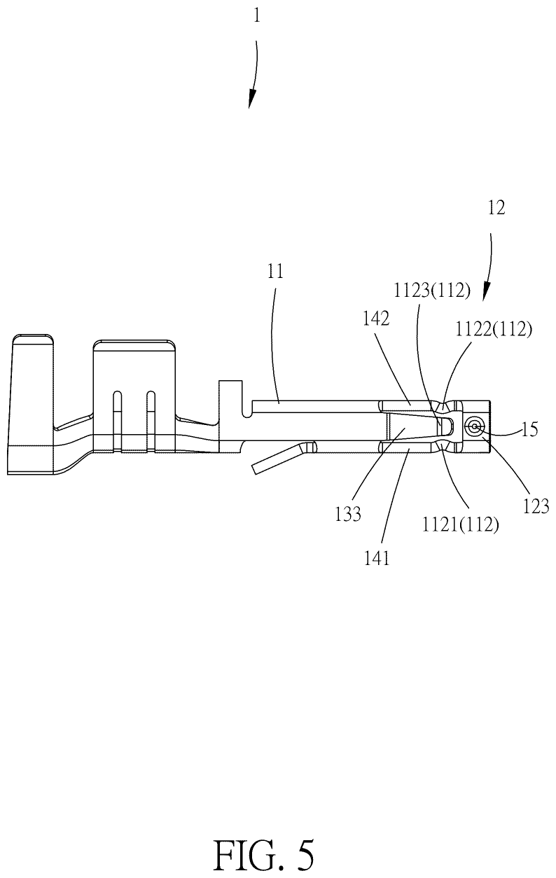

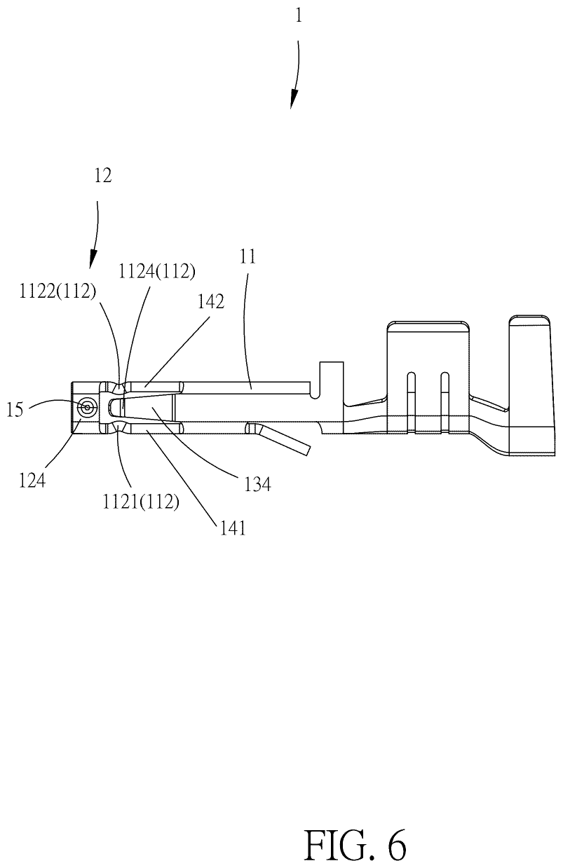

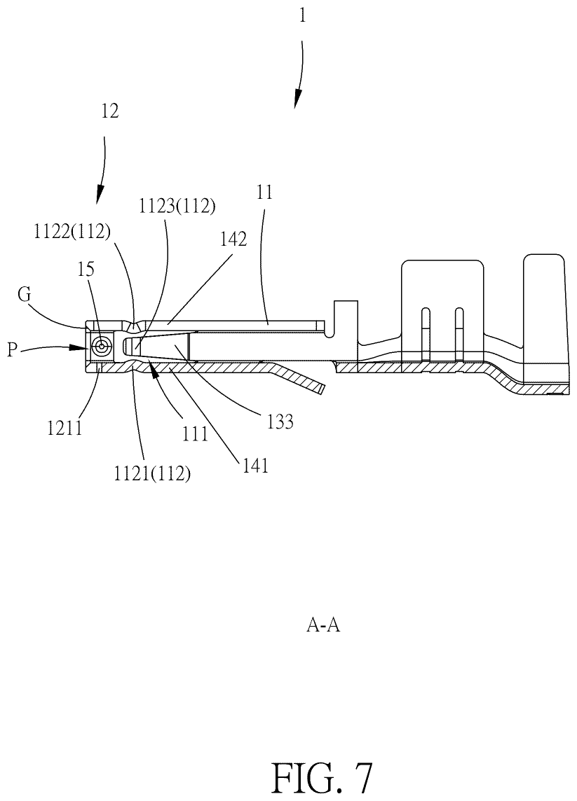

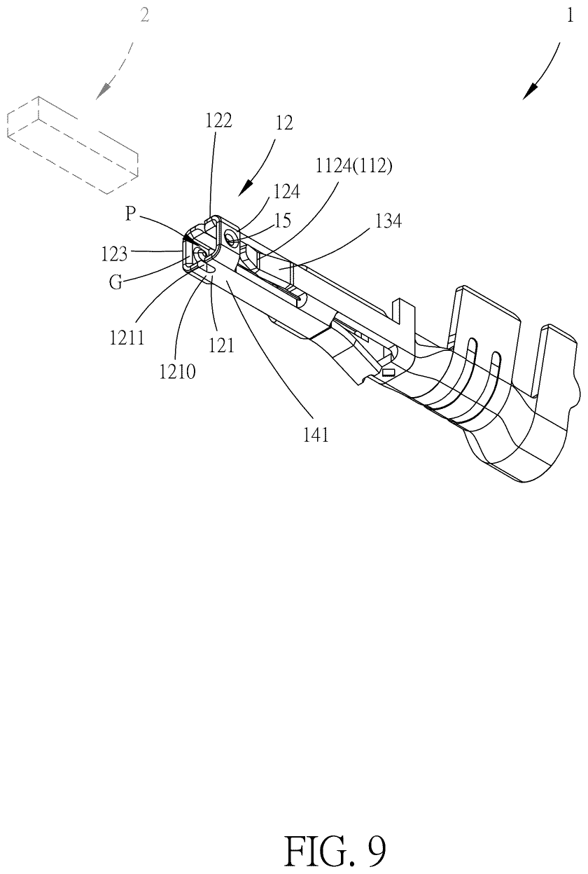

For a detailed description of the embodiments disclosed in the present application, please refer to FIGS. 1 to 9.

The present application provides a conductive terminal that enables a conductive component to join and transmit signals in an electronic product. The conductive terminal can be disposed in an electrical connector, and the conductive component can be inserted into the electrical connector to join the conductive terminal disposed therein, thereby transmitting electrical signals. The conductive component may be a component in the form of a conductive terminal or an electrical connector.

In the embodiments shown in FIGS. 1 to 9 of the present application, at least one conductive terminal 1 is disclosed. The conductive terminal 1 allows a conductive component 2 to join and comprises a terminal body 11 and a guiding frame body 12.

It should be noted that the terminal body 11 and the guiding frame body 12 may be integrally formed from a metal plate through bending, cutting, or other processing methods.

In the above embodiment, the terminal body 11 comprises a terminal internal space 111 and a terminal joining structure 112; and the guiding frame body 12 comprises a first frame wall 121, a second frame wall 122, a third frame wall 123, and a fourth frame wall 124, wherein the first frame wall 121 is respectively connected to the third frame wall 123 and the fourth frame wall 124, ensuring that the structural strength of the guiding frame body 12 meets expectations and forms part of a frame-shaped guiding structure G. Additionally, the second frame wall 122 is respectively connected to the third frame wall 123 and the fourth frame wall 124, ensuring that the structural strength of the guiding frame body 12 meets expectations and forms another part of the frame-shaped guiding structure G.

During the process of joining the conductive component 2 with the conductive terminal 1, the frame-shaped guiding structure G can guide the conductive component 2 into the terminal internal space 111 and join the terminal joining structure 112. It should be noted that when the frame-shaped guiding structure G guides the conductive component 2, the shape of the conductive component 2 may come into contact with the guiding frame body 12, causing deformation of the first frame wall 121, the second frame wall 122, the third frame wall 123, or the fourth frame wall 124. This allows the guiding frame body 12 to adapt to the shape of the conductive component 2, thereby preventing the first frame wall 121, the second frame wall 122, the third frame wall 123, or the fourth frame wall 124 from interfering with the conductive component 2 entering the terminal internal space 111, reducing the resistance generated when the conductive terminal 1 joins the conductive component 2 to prevent localized compression of the conductive terminal 1 by the conductive component 2, avoiding improper local deformation of the conductive terminal 1 and improving the reliability of the electrical connector in which the conductive terminal 1 is installed.

However, it is not limited to the above. It should be noted that when the frame-shaped guiding structure G guides the conductive component 2, the shape of the conductive component 2 may not come into contact with the guiding frame body 12 or may only contact at least one of the first frame wall 121, the second frame wall 122, the third frame wall 123, or the fourth frame wall 124. Therefore, the first frame wall 121, the second frame wall 122, the third frame wall 123, or the fourth frame wall 124 may not necessarily undergo deformation.

In the embodiments shown in FIGS. 1 to 4 and FIGS. 8 to 9, the first frame wall 121 comprises a first frame wall body 1210 and a first frame wall notch 1211, wherein the first frame wall notch 1211 extends inward from the edge of the first frame wall body 1210, allowing a structural weakness in the first frame wall 121. Thus, the first frame wall notch 1211 can weaken the structural strength of the first frame wall 121.

In the above embodiment, the inward extension length of the first frame wall notch 1211 is a first frame wall notch extension length L1. The connection length between the third frame wall 123 and the first frame wall 121 is a third frame wall connection length L3, and the connection length between the fourth frame wall 124 and the first frame wall 121 is a fourth frame wall connection length L4. Accordingly, the first frame wall notch extension length L1 is smaller than both the third frame wall connection length L3 and the fourth frame wall connection length L4, making the structural strength of the first frame wall 121 weaker than that of the third frame wall 123 and the fourth frame wall 124. As a result, when the frame-shaped guiding structure G guides the conductive component 2, the deformation of the first frame wall 121 is greater than that of the third frame wall 123 and the fourth frame wall 124, allowing the deformation of the frame-shaped guiding structure G to meet expectations and allows the conductive component 2 to be smoothly guided into the terminal internal space 111 and join the terminal joining structure 112.

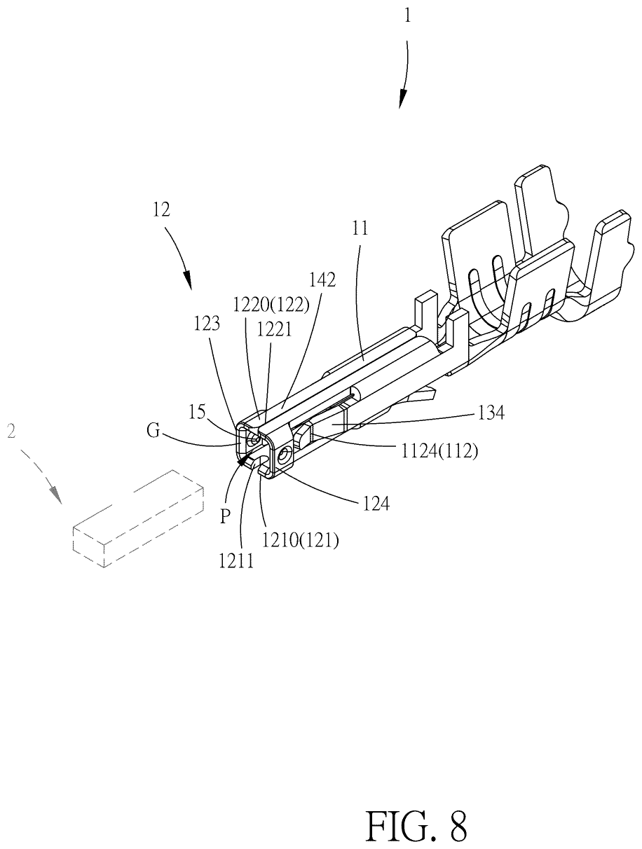

Additionally, in the embodiments shown in FIGS. 1 and 8, the second frame wall 122 comprises a second frame wall body 1220 and a second frame wall gap 1221, wherein the second frame wall gap 1221 extends inward from the edge of the second frame wall body 1220, allowing a structural weakness in the second frame wall 122. Thus, the second frame wall gap 1221 can weaken the structural strength of the second frame wall 122.

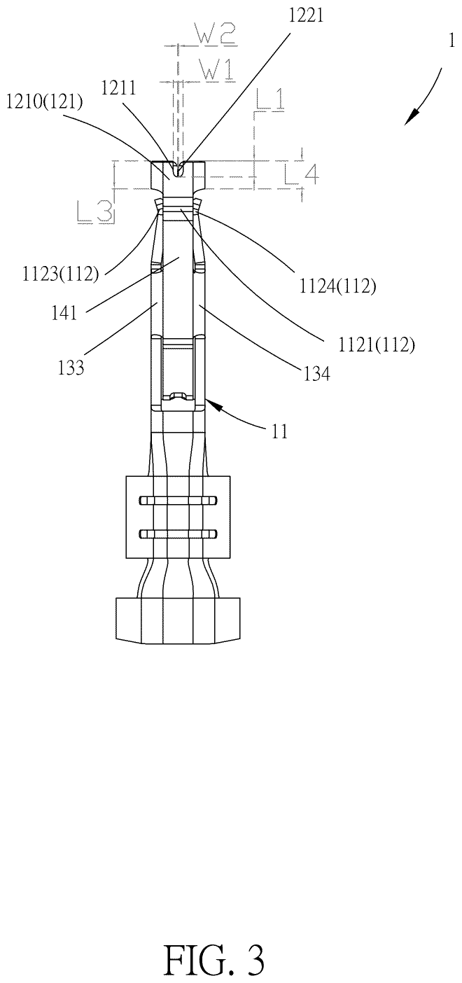

In the above embodiment, the width of the second frame wall gap 1221 is a second frame wall gap width W2, and correspondingly, the width of the first frame wall notch 1211 is a first frame wall notch width W1. As shown in FIG. 3, the first frame wall notch width W1 is greater than the second frame wall gap width W2, making the structural strength of the first frame wall 121 weaker than that of the second frame wall 122. As a result, when the frame-shaped guiding structure G guides the conductive component 2, the deformation of the first frame wall 121 is greater than that of the second frame wall 122, allowing the deformation of the frame-shaped guiding structure G to meet expectations and allows the conductive component 2 to be smoothly guided into the terminal internal space 111 and join the terminal joining structure 112.

In the embodiments shown in FIGS. 1 to 3 and FIGS. 5 to 9 of the present application, the conductive terminal 1 further comprise a third abutting arm 133 and a fourth abutting arm 134. The third abutting arm 133 is located on the same side as the third frame wall 123, and the fourth abutting arm 134 is located on the same side as the fourth frame wall 124, and the third abutting arm 133 and the fourth abutting arm 134 extend from the terminal body 11 into the terminal internal space 111, thereby respectively abutting the conductive component 2 that enters the terminal internal space 111. Accordingly, the terminal joining structure 112 comprises a third terminal joining substructure 1123 and a fourth terminal joining substructure 1124, wherein the third abutting arm 133 and the fourth abutting arm 134 respectively have free ends that accommodate the shape movement of the conductive component 2, and the third terminal joining substructure 1123 and the fourth terminal joining substructure 1124 are respectively disposed at the free ends of the third abutting arm 133 and the fourth abutting arm 134 to allow joining with the conductive component 2.

Optionally, the third terminal joining substructure 1123 and the fourth terminal joining substructure 1124 are bending structures. The third abutting arm 133 and the fourth abutting arm 134 are elastic cantilever arms, which can respectively accommodate the elastic deformation of the conductive component 2 entering the terminal internal space 111 and elastically abut the conductive component 2, thereby preventing the conductive component 2 from easily detaching from the terminal internal space 111. Furthermore, they provide an elastic force to push the conductive component 2 entering the terminal internal space 111 to an appropriate position, preventing the conductive component 2 from partially pressing against the conductive terminal 1 and causing improper local deformation of the conductive terminal 1, thereby improving the reliability of the electrical connector in which the conductive terminal 1 is installed.

In the embodiments shown in FIGS. 1 to 3 and FIGS. 5 to 9 of the present application, the conductive terminal 1 further comprise a first connecting arm 141 and a second connecting arm 142. The first connecting arm 141 and the second connecting arm 142 are respectively located on the same side as the first frame wall 121 and the second frame wall 122. The first connecting arm 141 connects the first frame wall 121 and the terminal body 11, ensuring that the structural strength of the conductive terminal 1 meets expectations and forming part of a joining passage P. The second connecting arm 142 connects the second frame wall 122 and the terminal body 11, ensuring that the structural strength of the conductive terminal 1 meets expectations and forming another part of the joining passage P. It should be noted that the frame-shaped guiding structure G can guide the conductive component 2 into the terminal internal space 111 via the joining passage P.

In the above embodiments, the terminal joining structure 112 comprises a first terminal joining substructure 1121 and a second terminal joining substructure 1122, as shown in FIGS. 1 to 3 and FIGS. 5 to 7. The first terminal joining substructure 1121 is disposed on the first connecting arm 141, and the second terminal joining substructure 1122 is disposed on the second connecting arm 142, enabling to join the conductive component 2 that enters the terminal internal space 111 via the joining passage P. Optionally, the first terminal joining substructure 1121 and the second terminal joining substructure 1122 are bending structures.

In the above embodiments, the second frame wall gap 1221 extends inward from the edge of the second frame wall body 1220 to the second connecting arm 142, creating a structural weakness in the second connecting arm 142. Consequently, the second frame wall gap 1221 reduces the structural strength of the second connecting arm 142, making it weaker than the first connecting arm 141. When the frame-shaped guiding structure G guides the conductive component 2, the deformation degree of the second connecting arm 142 is greater than that of the first connecting arm 141, ensuring that the deformation degrees of the first connecting arm 141 and the second connecting arm 142 meet expectations, allowing the conductive component 2 to smoothly enter the terminal internal space 111 and join with the terminal joining structure 112.

In the embodiments shown in FIGS. 1 to 2 and FIGS. 4 to 9 of the present application, the conductive terminal 1 further comprise a discharge contact structure 15. The discharge contact structure 15 is disposed on the third frame wall 123 or the fourth frame wall 124. During the process in which the frame-shaped guiding structure G guides the conductive component 2, the discharge contact structure 15 can contact the conductive component 2. The discharge contact structure 15 contacts the conductive component 2 earlier than the terminal joining structure 112 joins the conductive component 2, allowing the discharge contact structure 15 to provide discharge to the conductive component 2.

Optionally, the discharge contact structure 15 is a protruding structure that can contact the conductive component 2, utilizing the tip effect to provide electrostatic discharge, effectively preventing static electricity from entering an electronic product through the conductive terminal 1 and damaging the internal circuits of the electronic product.

It should be noted that in the above embodiments, some of the aforementioned components may be omitted. For example, in the present application, the conductive terminal may comprise only the terminal body and the guiding frame body. The terminal body comprises the terminal internal space and the terminal joining structure. The guiding frame body comprises the first frame wall, third frame wall, and fourth frame wall. The first frame wall is respectively connected to the third frame wall and the fourth frame wall to form part of the frame-shaped guiding structure. The frame-shaped guiding structure guides the conductive component into the terminal internal space and joins with the terminal joining structure. The first frame wall comprises the first frame wall body and the first frame wall notch. The first frame wall notch extends inward from the edge of the first frame wall body, with an inward extension length referred to as the first frame wall notch extension length. The connection length between the third frame wall and the first frame wall is referred to as the third frame wall connection length, and the connection length between the fourth frame wall and the first frame wall is referred to as the fourth frame wall connection length. The first frame wall notch extension length is smaller than both the third frame wall connection length and the fourth frame wall connection length, making the structural strength of the first frame wall weaker than that of the third frame wall and fourth frame wall. Consequently, when the frame-shaped guiding structure guides the conductive component, the deformation degree of the first frame wall is greater than that of the third frame wall and fourth frame wall.

In summary, the present application provides a conductive terminal capable of transmitting signals in an electronic product. The conductive terminal allows joining with a conductive component and comprises a terminal body and a guiding frame body. The guiding frame body guides the joining of the conductive component. When the conductive component joins, the guiding frame body deforms to accommodate the shape of the conductive component, thereby reducing the resistance generated during the joining of the conductive terminal with the conductive component, preventing the conductive component from partially pressing against the conductive terminal and causing improper local deformation of the conductive terminal, and ultimately improving the reliability of the electrical connector in which the conductive terminal is installed.

The examples above are only illustrative to explain principles and effects of the invention, but not to limit the invention. It will be apparent to those skilled in the art that modifications and variations can be made without departing from the spirit and scope of the invention. Therefore, the protection range of the rights of the invention should be as defined by the appended claims.

What is claimed is:

1. A conductive terminal, the conductive terminal being provided to join with a conductive component, the conductive terminal comprising:
a terminal body, the terminal body comprising a terminal internal space and a terminal joining structure; and
a guiding frame body, the guiding frame body comprising a first frame wall, a third frame wall, and a fourth frame wall, the first frame wall being respectively connected to the third frame wall and the fourth frame wall to form a part of a frame-shaped guiding structure; wherein
the frame-shaped guiding structure is able to guide the conductive component into the terminal internal space and join the terminal joining structure;
the first frame wall comprises a first frame wall body and a first frame wall notch, the first frame wall notch extending inward from an edge of the first frame wall body, wherein the inward extension length of the first frame wall notch is a first frame wall notch extension length, the connection length between the third frame wall and the first frame wall is a third frame wall connection length, and the connection length between the fourth frame wall and the first frame wall is a fourth frame wall connection length; and
the first frame wall notch extension length is smaller than the third frame wall connection length and the fourth frame wall connection length, so that the structural strength of the first frame wall is weaker than that of the third frame wall and the fourth frame wall, allowing the deformation degree of the first frame wall to be greater than that of the third frame wall and the fourth frame wall when the frame-shaped guiding structure guides the conductive component.

2. The conductive terminal of claim 1, further comprising: a third abutting arm and a fourth abutting arm, the third abutting arm being positioned on the same side as the third frame wall, and the fourth abutting arm being positioned on the same side as the fourth frame wall, and the third abutting arm and the fourth abutting arm respectively extending from the terminal body to abut against the conductive component entering the terminal internal space; and the terminal joining structure comprising a third terminal joining substructure and a fourth terminal joining substructure, the third terminal joining substructure being disposed on the third abutting arm, and the fourth terminal joining substructure being disposed on the fourth abutting arm to join the conductive component.

3. The conductive terminal of claim 2, wherein the third abutting arm and the fourth abutting arm are elastic cantilever arms.

4. The conductive terminal of claim 1, wherein the guiding frame body further comprises a second frame wall, the second frame wall being respectively connected to the third frame wall and the fourth frame wall to form another part of the frame-shaped guiding structure; wherein
the second frame wall comprise a second frame wall body and a second frame wall gap, the second frame wall gap extending inward from an edge of the second frame wall body, the width of the second frame wall gap being a second frame wall gap width, and the width of the first frame wall notch being a first frame wall notch width; and
the first frame wall notch width is greater than the second frame wall gap width, so that the structural strength of the first frame wall is weaker than that of the second frame wall, allowing the deformation degree of the first frame wall to be greater than that of the second frame wall when the frame-shaped guiding structure guides the conductive component.

5. The conductive terminal of claim 4, further comprising: a first connecting arm and a second connecting arm, the first connecting arm being positioned on the same side as the first frame wall, and the second connecting arm being positioned on the same side as the second frame wall, wherein the first connecting arm connects the first frame wall and the terminal body to form a part of a joining passage, and the second connecting arm connects the second frame wall and the terminal body to form another part of the joining passage; wherein the frame-shaped guiding structure is able to guide the conductive component into the terminal internal space via the joining passage.

6. The conductive terminal of claim 5, wherein the second frame wall gap extends to the second connecting arm, making the structural strength of the second connecting arm weaker than that of the first connecting arm, so that when the frame-shaped guiding structure guides the conductive component, the deformation degree of the second connecting arm is greater than that of the first connecting arm.

7. The conductive terminal of claim 5, wherein the terminal joining structure comprise a first terminal joining substructure and a second terminal joining substructure, the first terminal joining substructure and the second terminal joining substructure being respectively disposed on the first connecting arm and the second connecting arm to join the conductive component.

8. The conductive terminal of claim 1, further comprising:
a discharge contact structure, the discharge contact structure being disposed on the third frame wall or the fourth frame wall, wherein during the process in which the frame-shaped guiding structure guides the conductive component, the discharge contact structure contacts the conductive component to provide discharge to the conductive component, and the time at which the discharge contact structure contacts the conductive component is earlier than the time at which the terminal joining structure joins the conductive component.

9. The conductive terminal of claim 8, wherein the discharge contact structure is a protruding structure.
